(19) United States
(12) Patent Application Publication
(10) Pub. No.: US 2023/0410065 A1
(43) Pub. Date: Dec. 21, 2023

(54) Systems and Method for Managing an Ethereum Name Service for Blockchain-Based Platforms

(71) Applicant: Bo Zhang, Sacramento, CA (US)

(72) Inventor: Bo Zhang, Sacramento, CA (US)

(21) Appl. No.: 17/845,056

(22) Filed: Jun. 21, 2022

(51) Int. Cl. G06Q 20/06; G06Q 20/38

(52) U.S. Cl. CPC G06Q 20/065; G06Q 20/382; G06Q 2220/00

(57) ABSTRACT

A system and method for managing an Ethereum Name Service or other non-fungible token collections for blockchain-based platforms is provided. The system includes an electronic device, such as a computer, phone, or tablet, having a processor that executes instructions stored on memory. The instructions cause the processor to extract, by a network communications interface, on-chain data from a blockchain, wherein the on-chain data includes the collection's name and identify, by network communications interface, one or more nonfungible tokens owners associated with the domain names. The domain names are shown on a display in a map format. Profiles may be created and associated with the domain names or non-fungible token owner names. In one embodiment, the domain names, in the map format, Example collection could be Ethereum Name Service's non fungible token ranging from “000.eth” to “9999.eth.”, or any other non-fungible collection such as “boredape#0001” to “boredape#9999.”

### BACKGROUND OF THE INVENTION

The present invention relates to a system and method for managing an Ethereum Name Service for blockchain-based platforms. More specifically, the present invention relates to a system for managing an Ethereum Name Service that allows for identification of “.eth” domain owners. The system provides a graphical user interface that includes a map format of a selected group of domains and provides information related to the ownership, expiration, and the like.

The Ethereum Name Service (ENS) is a domain name provider for the Ethereum blockchain. The ENS is controlled by a DAO, or decentralized autonomous organization, which uses governance tokens to make collective decisions. ENS domains are secure domain names for the decentralized world. ENS domains provide a way for users to map human readable names to blockchain and non-blockchain resources, like Ethereum addresses or website URIs.

Each ENS web name is a nonfungible token (NFT) that is minted and sold like any other nonfungible token. These decentralized domains that end in “.eth” can act like Ethereum wallet addresses, cryptographic hashes, and website URLs. One example of an ENS domain is “0004.eth.” The “.eth” is a top-level domain which can be bought and sold on secondary markets.

Today, ENS domains are most commonly used as a simple, readable alternative to a traditional Ethereum wallet address, which consists of forty-two hexadecimal characters, ENS domains are touted by their proponents as the future for decentralized, uncensorable websites, and a potential universal login for all things Web 3.0. Like the web domain craze of the early internet, ENS names with fewer characters are easier to read, spell, and search.

ENS domains ranging from 000.eth to 9999.eth have caused a stir among NFT investors, speculators, and enthusiasts alike. Even though three- and four-digit names have been around for years, the number of people registering for ENS domains and purchasing these digits domain names on secondary markets has significantly affected the market's trading volume.

Moreover, there has been a desire for NFT communities to connect with each other and share passions and ideas. As an attempt to form a community around likeminded owners of domain names, the present invention provides a platform for keeping up to date ownership records of the owners of these three to four digit “.eth” domain name owners, provide identifiable and verified profiles of the owners, and a marketplace to buy and sell these three to four digit .eth domain names.

Currently, there is not a platform for owners to connect with other owners, wherein they can register, purchase, or otherwise connect with similarly situated people. Having a platform specific to “.eth” domain names and other blockchain oriented systems causes a detriment to the market for lack of access to the owners.

In light of the devices disclosed in the known art, it is submitted that the present invention substantially diverges in design elements and methods from the known art and consequently it is clear that there is a need in the art for an improvement for a systems and method for managing an Ethereum Name Service for blockchain-based platforms. In this regard the instant invention substantially fulfills these needs.

### SUMMARY OF THE INVENTION

In view of the foregoing disadvantages inherent in the known types of systems and methods for managing an Ethereum Name Service for blockchain-based platforms now present in the known art. The present invention provides a new system and method for managing an Ethereum Name Service (ENS) for blockchain-based platforms wherein the same can be utilized for showing ENS domain names, providing a map of a selected group of ENS domain names, and allow users to include profiles that link to their owned domain.

It is an objective of the present invention to provide a systems and method for managing a blockchain-based platform comprising an electronic device having a processor, a network communications interface, and a non-transitory memory. The non-transitory memory includes instructions, which, when executed by the processor, causes the processor to: extract, by network communications interface, on-chain data from a blockchain, wherein the on-chain data includes domain names; identify, by network communications interface, one or more domain owners associated with the domain names; and display, via a display, a graphical interface to indicate the corresponding position of a group of domain names, wherein the domain names are shown in a sequential order.

It is another objective of the present invention to provide a map having rows and columns of each individual domain owners to provide a visual representation of each owner for convenience and accessibility.

The present invention further provides a method of: providing a server having a processor and a network communications interface; extracting, by a network communications interface, on-chain data from a blockchain, wherein the on-chain data includes domain names; identifying, by network communications interface, one or more domain owners associated with the domain names; sending the on-chain data to an electronic device having a display; displaying, via the display, a graphical interface to indicate the corresponding position of a group of domain names, wherein the domain names are shown in a sequential order.

It is therefore an object of the present invention to provide a new and improved system and method for managing a blockchain-based platform, such as an Ethereum Name Service, that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a system diagram of an embodiment of the system for managing a blockchain-based platform.

FIG. 2 shows a view of flowchart of an embodiment of the method and instructions of the electronic device managing a blockchain-based platform.

FIG. 3 shows a view of a map format of a selected group of ENS domain names arranged in consecutive order, in rows and columns of the graphic user interface.

FIG. 4 shows a view of a graphical interface of one of the ENS domain names with domain name owner information and other profile information.

### DETAILED DESCRIPTION OF THE INVENTION

Reference is made herein to the attached drawings. Like reference numerals are used throughout the drawings to depict like or similar elements of the system and method for managing a blockchain-based platform. For the purposes of presenting a brief and clear description of the present invention, the preferred embodiment will be discussed as used for extracting on-chain data from a blockchain, displaying a selected group of domain names, and linking a profile to one or more of the domain names. The figures are intended for representative purposes only and should not be considered to be limiting in any respect. Furthermore, the described features, structures, or characteristics may be combined in any suitable manner in one or more embodiments. In the following description, numerous specific details are provided to give a thorough understanding of embodiments.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment. Moreover, use of “Ethereum Name Service”, “ENS”, “domain name”, or “domain naming service” is to include non-fungible tokens and non-fungible token collections.

As used herein, “computer-readable medium” or “memory” excludes any transitory signals, but includes any non-transitory data storage circuitry, e.g., buffers, cache, and queues, within transceivers of transitory signals. As used herein, “logic” refers to (i) logic implemented as computer instructions and/or data within one or more computer processes and/or (ii) logic implemented in electronic circuitry. References to “display” or “display screen” include any electronic device, such as a computer or a tablet having an interactive touchscreen.

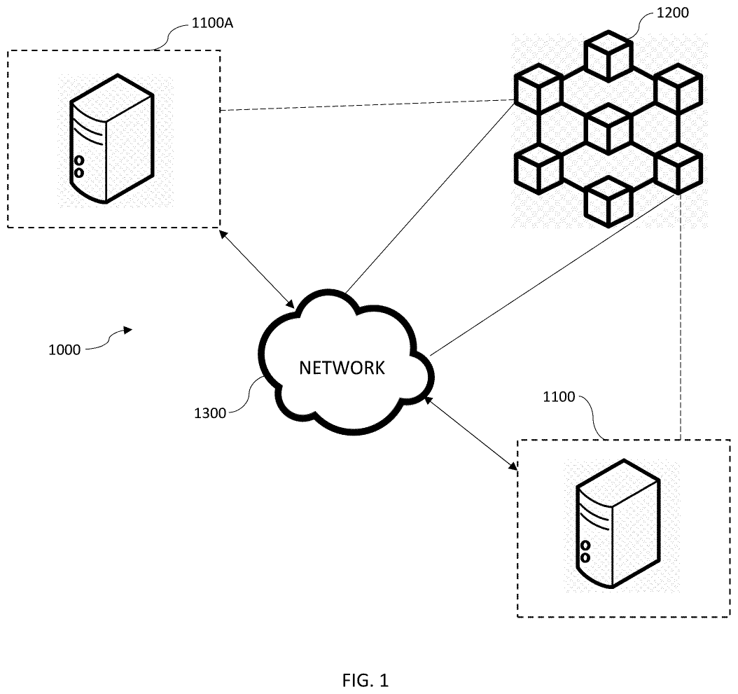

Referring now to FIG. 1, there is shown a system diagram of an embodiment of the system for managing a blockchain-based platform. The system provides a platform for connecting domain owner users wherein the identified group of domain owners form a community. The system for managing a blockchain-based platform 1000 comprises an electronic device 1100 that communicates with a blockchain 1200 (i.e., systems that implement the blockchain). The electronic device 1100 can be any device with network connectivity including but not limited to: desktop computers, laptop computers, smartphones, tablet computers, wearable devices, and the like. In the shown embodiment, the electronic device 1100 is connected to the network 1300 which is in turn connected to other electronic devices 1100A and the blockchain. The electronic device comprises a processor with non-transitory memory 1110 operable to store instructions, which, when executed by the processor, causes the processor to execute those instruction. Moreover, the electronic device 1100 includes a network communications interface 1120. The network communications interface 1120 may include a network communications module having various components for establishing and maintaining network connections (e.g., software for implementing communication protocols, such as TCP/IP, HTTP, etc.).

In one embodiment, the network communications interface 1120 includes communications through a wireless network 1300. Some examples of wireless networks include a wireless local area network (WLAN), such as the Internet, and a wireless personal area network (WPAN). Some examples of communication technologies include any suitable IEEE 802.xx technology, including but not limited to Wi-Fi and Bluetooth.

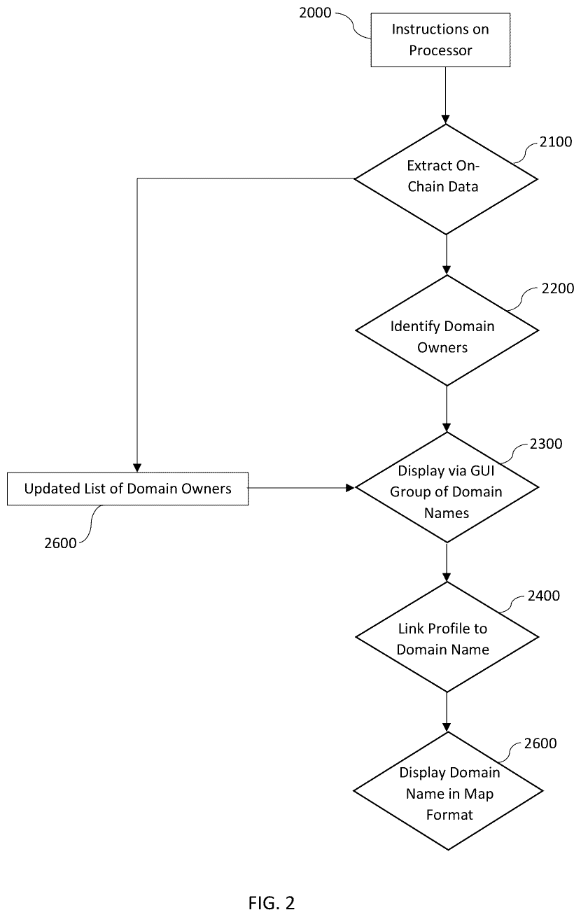

Referring now to FIG. 2, there is shown a view of flowchart of an embodiment of the method and instructions of the electronic device managing a blockchain-based platform. In one embodiment, the electronic device 1100 for managing a blockchain-based platform comprises a non-transitory memory 1110 operable to store instructions 2000, which, when executed by the processor, causes the processor to: extract 2100, by network communications interface, on-chain data from a blockchain, wherein the on-chain data includes domain names; identify 2200, by network communications interface, one or more domain owners associated with the domain names; display 2300, via a display, a graphical interface to indicate the corresponding position of a group of domain names, wherein the domain names are shown in a sequential order.

In an embodiment, a non-transitory, computer-readable storage medium having instructions stored thereon causes one or more processors to perform operations comprising: sending, to a server, the on-chain data from the blockchain and receiving, from the server, an updated list of the domain owners associated with the domain names. Moreover, the electronic device is adapted to display, on the graphical interface, an option to link 2400 a profile to one of the domain names. The profile may include information related to the ownership of the domain name. The system may include a website for interacting with the system, wherein the website provides selectable buttons to engage the system. The electronic device includes an input/output device, wherein the system receives, by the input/output device, a request to associate one of the domain owners with a profile login. In one embodiment, the input/output device comprises a mouse, keyboard, touchscreen, and the like.

Additionally, the processor is adapted to display 2500, by the graphical interface, each individual domain owners in a map format having rows and columns. Memory may also store communication instructions to facilitate communicating with one or more additional devices, one or more computers or servers, including peer-to-peer communications. In some embodiments, the instructions further cause the one or more processors to automatically update 2600 the map format upon sale or transfer of the one or more domain names. The transfers and ownership of domain names are publicly accessible via the blockchain. In this way, the profile and ownership of the domain name are verifiable.

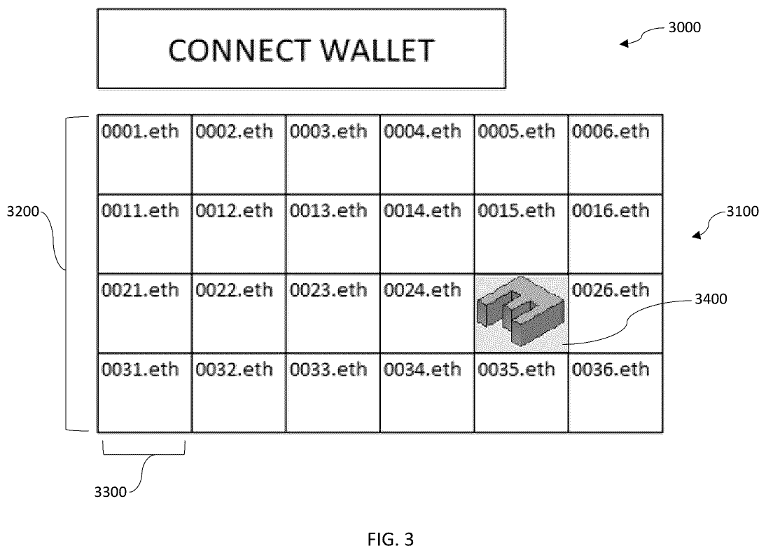

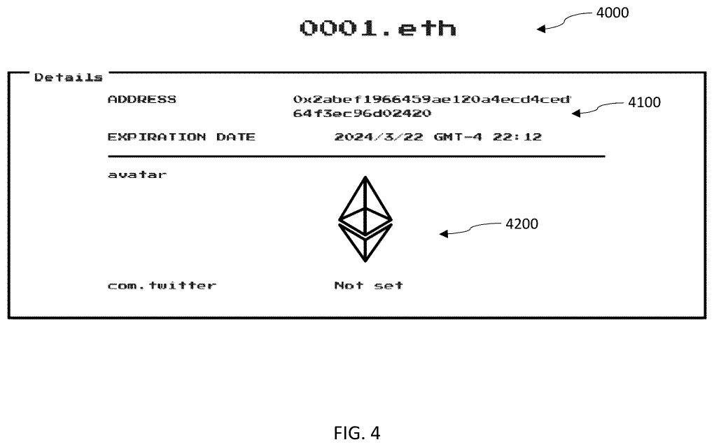

Referring now to FIGS. 3 and 4, there are shown views of a map format of a selected group of ENS domain names arranged in consecutive order, in rows and columns of the graphic user interface, and a view of a graphical interface of one of the ENS domain names with domain name owner information and other profile information, respectively. In the shown embodiment, the graphic user interface 3000 shows a partial map 3100 of a selected group of domain names. In one embodiment, the map 3000 wherein the domain names in the map format comprise domain names ranging from “000.eth” to “999.eth”. In an alternative embodiment, the domain names in the map format comprise domain names ranging from “000.eth” to “9999.eth.” In yet another alternative embodiment, the domain names in the map format comprise domain names ranging from “0000.eth” to “9999.eth.” In some embodiment, the range of domain names may range from more than “9999.eth.” In this context, the size of domain names is sequential from three-digits between “000.eth” to “999.eth” and from four-digits between “0000.eth” to “9999.eth,” wherein the four-digit domain names are larger than the three-digit domain names.

In the shown embodiment, the graphical user interface 3000 shows each individual domain owners in a map format having rows 3200 and columns 3300. Once the profile is linked with one of the domain names, the user of the profile may selectively include a profile avatar 3400 or other image and claim a position on the map 3100. In this way, the profile user allows themselves to express themselves and show other owners of the domain names their position with respect to their neighbors. In some embodiment, the wallet of the domain owner is needed to create the profile. The configuration of the map allows a potential purchaser or owner to easily locate unclaimed “.eth” domain names. In other embodiments, the map format is applicable to any non-fungible token collections, including but not limited to, “Bored Ape Yacht Club”, “Sappy Seals”, and the like.

As shown in FIG. 4, the graphical interface of one of the “0.0001.eth” ENS domain name 4000 is shown with the domain name owner information and other profile information. The Ethereum wallet address 4100 which consists of forty-two hexadecimal characters is displayed. Moreover, the expiration date of the domain name is shown, as well as the selected profile avatar 4200. Other social media profiles are also linkable through the user profile.

In one embodiment, the instructions further cause the one or more processors to provide pricing by linking to other ETH based marketplaces. The system may provide a marketplace for buying and selling the domain names. For example, the marketplace may provide a way of filtering particular domain names, by name, number, price, availability, expiration date, length, and the like.

In one embodiment, the present invention comprises a method for managing a blockchain-based platform, the method comprising: providing a server having a processor and a network communications interface; extracting, by a network communications interface, on-chain data from a blockchain, wherein the on-chain data includes domain names; identifying, by network communications interface, one or more domain owners associated with the domain names; sending the on-chain data to an electronic device having a display; displaying, via the display, a graphical interface to indicate the corresponding position of a group of domain names, wherein the domain names are shown in a sequential order.

In one embodiment, the method further comprises: sending, from the server to the electronic device, an updated list of the domain owners associated with the domain names; displaying, on the graphical interface of the electronic device, an option to link a profile to one of the domain names; receiving a request by the electronic device to associate one of the domain owners with a profile login; displaying, by the graphical interface of the electronic device, each individual domain owners in a map format having rows and columns, wherein the domain names comprise ENS domains; and automatically updating the map format upon sale or transfer of the one or more domain names.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An electronic device for managing a blockchain-based platform, comprising:
a processor;
a network communications interface;
a non-transitory memory operable to store instructions, which, when executed by the processor, causes the processor to:
extract, by network communications interface, on-chain data from a blockchain, wherein the on-chain data includes domain names;
identify, by network communications interface, one or more domain owners associated with the domain names;
display, via a display, a graphical interface to indicate the corresponding position of a group of domain names, wherein the domain names are shown in a sequential order.

2. The electronic device of claim 1, the instructions further cause the one or more processors to:
send, to a server, the on-chain data from the blockchain;
receive, from the server, an updated list of the domain owners associated with the domain names.

3. The electronic device of claim 1, the instructions further cause the one or more processors to:
display, on the graphical interface, an option to link a profile to one of the domain names;
receive, by an input/output device, a request to associate one of the domain owners with a profile login.

4. The electronic device of claim 3, the instructions further cause the one or more processors to:
display, by the graphical interface, each individual domain owners in a map format having rows and columns.

5. The electronic device of claim 3, wherein the domain names comprise ENS domains.

6. The electronic device of claim 5, wherein the domain names in the map format comprise domain names ranging from “000.eth” to “999.eth”.

7. The electronic device of claim 5, wherein the domain names in the map format comprise domain names ranging from “000.eth” to “9999.eth”.

8. The electronic device of claim 5, wherein the domain names in the map format comprise domain names ranging from “0000.eth” to “9999.eth”.

9. The electronic device of claim 3, the instructions further cause the one or more processors to:
automatically update the map format upon sale or transfer of the one or more domain names.

10. The electronic device of claim 3, the instructions further cause the one or more processors to:
provide pricing by linking to other ETH based marketplaces.

11. The electronic device of claim 3, the instructions further cause the one or more processors to:
filter the ENS domains by alphanumerical parameters.

12. A method for managing a blockchain-based platform, comprising:
providing a server having a processor and a network communications interface;
extracting, by a network communications interface, on-chain data from a blockchain, wherein the on-chain data includes domain names;
identifying, by network communications interface, one or more domain owners associated with the domain names;
sending the on-chain data to an electronic device having a display;
displaying, via the display, a graphical interface to indicate the corresponding position of a group of domain names, wherein the domain names are shown in a sequential order.

13. The method for managing a blockchain-based platform of claim 12, further comprising:
sending, from the server to the electronic device, an updated list of the domain owners associated with the domain names.

14. The method for managing a blockchain-based platform of claim 13, further comprising:
displaying, on the graphical interface of the electronic device, an option to link a profile to one of the domain names;
receiving a request by the electronic device to associate one of the domain owners with a profile login.

15. The method for managing a blockchain-based platform of claim 14, further comprising:
displaying, by the graphical interface of the electronic device, each individual domain owners in a map format having rows and columns.

16. The electronic device of claim 15, wherein the domain names comprise ENS domains.

17. The method for managing a blockchain-based platform of claim 16, further comprising:
automatically updating the map format upon sale or transfer of the one or more domain names.
